(19) United States
(12) Patent Application Publication
(10) Pub. No.: US 2015/0373713 A1
(43) Pub. Date: Dec. 24, 2015

(54) METHOD AND APPARATUS FOR ALLOCATING RESOURCE IN CARRIER AGGREGATION SYSTEM

(71) Applicant: Electronics and Telecommunications Research Institute, Daejeon (KR)

(72) Inventors: Sang Chul OH, Daejeon (KR); Kyung Sook KIM, Daejeon (KR); Byung-Han RYU, Daejeon (KR); YEON SEUNG SHIN, Daejeon (KR)

(21) Appl. No.: 14/725,945

(22) Filed: May 29, 2015

(30) Foreign Application Priority Data
Jun. 18, 2014 (KR) 10-2014-0074533

(51) Int. Cl. H04W 72/04; H04W 28/16; H04L 12/26; H04L 1/18; H04L 5/14

(52) U.S. Cl. CPC H04W 72/0453; H04L 1/1812; H04L 5/14; H04L 43/0864; H04W 28/16; H04W 88/02

(57) ABSTRACT

A base station of a carrier aggregation system sets a time division duplex (TDD) component carrier of a plurality of TDD component carriers to a primary serving cell of a terminal and sets at least one frequency division duplex (FDD) component carrier of a plurality of FDD component carriers to a secondary serving cell of the terminal, and when a hybrid automatic repeat request-round trip time (HARQ RTT) value of a TDD component carrier of a primary serving cell of the terminal does not satisfy a quality of service (QoS) requirement of a service that the terminal requests, the base station changes a HARQ feedback transmitting resource that is set to the terminal.

### CROSS-REFERENCE TO RELATED APPLICATION

This application claims priority to and the benefit of Korean Patent Application No. 10-2014-0074533 filed in the Korean Intellectual Property Office on Jun. 18, 2014, the entire contents of which are incorporated herein by reference.

### BACKGROUND OF THE INVENTION

1. (a) Field of the Invention

The present invention relates to a method and apparatus for allocating a resource in a carrier aggregation system. More particularly, the present invention relates to a method and apparatus for allocating a resource that can reduce data transmission delay in a system that aggregates and uses frequency division duplex (FDD) and time division duplex (TDD) component carriers operating with an FDD method and a TDD method.

2. (b) Description of the Related Art

A carrier aggregation system is a system that aggregates at least one component carrier having a smaller bandwidth than a target wideband to form a wideband, when a wireless communication system attempts to support a wideband.

In the carrier aggregation system, a serving cell may be used instead of a term “component carrier”. Here, a serving cell is formed with a pair of two component carriers such as a downlink component carrier and an uplink component carrier, or is formed with only a downlink component carrier. The carrier aggregation system is a system in which a plurality of serving cells are set to a terminal. Therefore, the terminal may transmit and receive data through a plurality of component carriers. In this case, a serving cell of a plurality of serving cells is set to a primary serving cell, the remaining serving cells are set to secondary serving cells, the primary serving cell always maintains an active state, and the secondary serving cells are activated or inactivated according to a specific condition.

In such a carrier aggregation system, when a TDD component carrier is used as a primary serving cell and an FDD component carrier is used as a secondary serving cell, a Hybrid Automatic Repeat reQuest (HARQ) feedback signal (ACK/NACK) that should be transmitted to the primary serving cell is delayed by TDD uplink-downlink configuration characteristics. That is, because an uplink resource is not continued in view of TDD uplink-downlink configuration characteristics, transmission of a HARQ feedback signal (ACK/NACK) is delayed. Therefore, there is a problem that user data is delayed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for allocating a resource having advantages of minimizing delay of user data due to delay of a HARQ feedback signal in a carrier aggregation system.

An exemplary embodiment of the present invention provides a method of allocating a resource in a base station of a carrier aggregation system that aggregates and communicates a plurality of component carriers. The method includes: setting a TDD component carrier of a plurality of TDD component carriers to a primary serving cell of a terminal and setting at least one FDD component carrier of a plurality of FDD component carriers to a secondary serving cell of the terminal; receiving a service request from the terminal; and changing a HARQ feedback transmitting resource that is set to the terminal, when a hybrid automatic repeat request-round trip time (HARQ RTT) value of a TDD component carrier of the primary serving cell of the terminal does not satisfy a quality of service (QoS) requirement of a service that the terminal requests.

The changing a HARQ feedback transmitting resource may include setting a primary serving cell of the terminal to a TDD component carrier having a HARQ RTT value satisfying the QoS requirement of a service that the terminal requests among the plurality of TDD component carriers.

The method may further include receiving HARQ feedback from the terminal through the primary serving cell.

The changing of a HARQ feedback transmitting resource may include setting a HARQ feedback transmitting resource of the terminal to a secondary serving cell satisfying the QoS requirement of a service that the terminal requests.

The method may further include receiving HARQ feedback from the terminal through the secondary serving cell.

The changing of a HARQ feedback transmitting resource may include changing a TDD uplink-downlink configuration of a TDD component carrier of the primary serving cell to a TDD uplink-downlink configuration satisfying the QoS requirement of a service that the terminal requests.

The QoS requirement may include transmission delay.

The method may further include monitoring a HARQ RTT value of the plurality of TDD component carriers and the plurality of FDD component carriers.

The primary serving cell may include a primary component carrier that is allocated to an uplink and a primary component carrier that is allocated to a downlink as a pair, and the secondary serving cell may include a secondary component carrier that is allocated to an uplink and a secondary component carrier that is allocated to a downlink as a pair or only a secondary component carrier that is allocated to a downlink.

Another embodiment of the present invention provides a resource allocation apparatus that allocates a resource in a carrier aggregation system that aggregates and communicates a plurality of TDD component carriers and a plurality of FDD component carriers. The resource allocation apparatus includes a HARQ RTT monitoring unit and a resource management unit. The HARQ RTT monitoring unit monitors a HARQ RTT value of the plurality of TDD component carriers and the plurality of FDD component carriers. The resource management unit changes a HARQ feedback transmitting resource that is set to a terminal according to a QoS requirement of a service that the terminal requests in a state that sets a TDD component carrier of a plurality of TDD component carriers to a primary serving cell of the terminal and that sets at least one FDD component carrier of a plurality of FDD component carriers to a secondary serving cell of the terminal.

The resource management unit may change a TDD component carrier of a primary serving cell of the terminal to a TDD component carrier having a HARQ RTT value satisfying the QoS requirement of a service that the terminal requests, and a transmitting resource of the HARQ feedback may include the primary serving cell.

The resource management unit may change a transmitting resource of the HARQ feedback from the primary serving cell to a secondary serving cell satisfying the QoS requirement of a service that the terminal requests among the at least one secondary serving cell.

The resource management unit may change a TDD uplink-downlink configuration of a primary serving cell of the terminal to use as a transmitting resource of the HARQ feedback based on the QoS requirement of a service that the terminal requests.

The QoS requirement may include transmission delay.

The resource allocation apparatus may further include a transmitting and receiving unit. The transmitting and receiving unit may transmit resource allocation information of a primary serving cell and a secondary serving cell to set to the terminal and receive HARQ feedback through the HARQ feedback transmitting resource from the terminal.

### BRIEF DESCRIPTION OF THE DRAWINGS

FIG. 1 is a diagram illustrating an example of a carrier aggregation system according to an exemplary embodiment of the present invention.

FIG. 2 is a diagram illustrating an example of a radio frame according to an exemplary embodiment of the present invention.

FIG. 3 is a diagram illustrating an example of a downlink component carrier and an uplink component carrier according to an exemplary embodiment of the present invention.

FIG. 4 is a diagram illustrating an example of a method of allocating a serving cell in a base station according to an exemplary embodiment of the present invention.

FIG. 5 is a diagram illustrating a HARQ technique according to an exemplary embodiment of the present invention.

FIG. 6 is a flowchart illustrating a method of allocating a resource of a base station according to a first exemplary embodiment of the present invention.

FIG. 7 is a flowchart illustrating a method of allocating a resource of a base station according to a second exemplary embodiment of the present invention.

FIG. 8 is a block diagram illustrating a configuration of a resource allocation apparatus of a base station according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

In the entire specification, a terminal may indicate a mobile terminal (MT), a mobile station (MS), an advanced mobile station (AMS), a high reliability mobile station (HR-MS), a subscriber station (SS), a portable subscriber station (PSS), an access terminal (AT), and user equipment (UE), and may include an entire function or a partial function of the MT, the MS, the AMS, the HR-MS, the SS, the PSS, the AT, and the UE.

Further, a base station (BS) may indicate an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) that performs a BS function, a relay node (RN) that performs a BS function, an advanced relay station (ARS) that performs a BS function, a high reliability relay station (HR-RS) that performs a BS function, and a small-sized BS [a femto BS, a home node B(HNB), a home eNodeB (HeNB), a pico BS, a metro BS, and a micro BS], and may include an entire function or a partial function of the ABS, the nodeB, the eNodeB, the AP, the RAS, the BTS, the MMR-BS, the RS, the RN, the ARS, the HR-RS, and the small-sized BS.

Hereinafter, a method and apparatus for controlling interference in a carrier aggregation system according to an exemplary embodiment of the present invention will be described in detail with reference to the drawings.

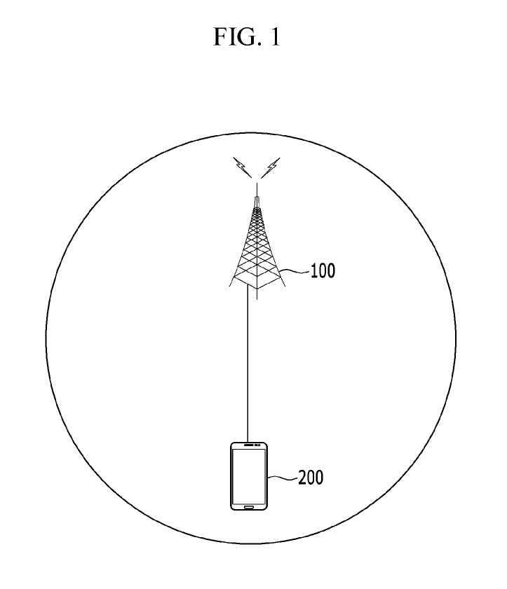

FIG. 1 is a diagram illustrating an example of a carrier aggregation system according to an exemplary embodiment of the present invention.

Referring to FIG. 1, the carrier aggregation system is a wireless communication system that aggregates a plurality of component carriers to form a wideband.

The carrier aggregation system may include at least one base station 100. The base station 100 provides a communication service to a terminal 200 within a cell that the base station 100 manages. To this end, the base station 100 manages a plurality of component carriers and allocates a component carrier to the terminal 200.

The base station 100 determines the number of available component carriers of the terminal 200, and allocates a component carrier to the terminal 200 based on number information of available component carriers of the terminal 200. A plurality of component carriers may include a component carrier (hereinafter referred to as an “FDD component carrier”) operating with a frequency division duplex (FDD) method and a component carrier (hereinafter referred to as a “TDD component carrier”) operating with a time division duplex (TDD) method. The component carrier may be classified into a primary component carrier and a secondary component carrier.

The terminal 200 may use only a primary component carrier of component carriers that are allocated from the base station 100, or may aggregate and use at least one secondary component carrier together with a primary component carrier.

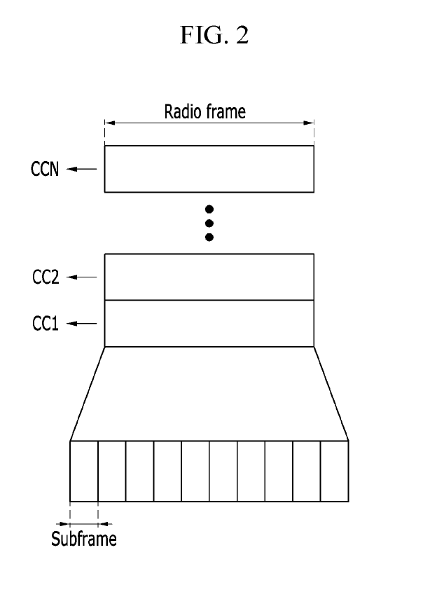

FIG. 2 is a diagram illustrating an example of a radio frame according to an exemplary embodiment of the present invention.

Referring to FIG. 2, the frame has a length of 10 ms and includes 10 subframes. The base station 100 manages a plurality of component carriers (CC1-CCN), and the terminal 200 may receive allocation of at least one component carrier from the base station 100 and use at least one component carrier. For example, the terminal 200 may aggregate and use component carriers CC1 and CC2 among the allocated component carriers.

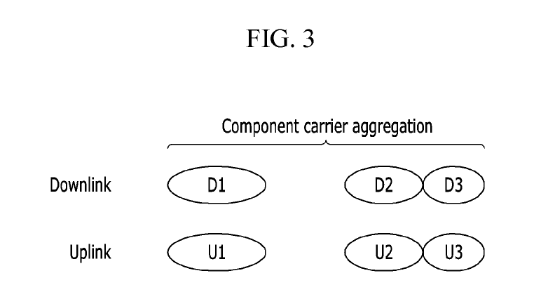

FIG. 3 is a diagram illustrating an example of a downlink component carrier and an uplink component carrier according to an exemplary embodiment of the present invention.

Referring to FIG. 3, the base station 100 may allocate at least one component carrier of D1, D2, and D3 for a downlink and allocate at least one component carrier of U1, U2, and U3 for an uplink. In this case, a component carrier that is allocated to the downlink is referred to as a downlink component carrier, and a component carrier that is allocated to the uplink is referred to as an uplink component carrier. The number of downlink component carriers and the number of uplink component carriers may be the same or different. At least one downlink component carrier is a primary component carrier and the remaining downlink component carriers are secondary component carriers. Similarly, at least one uplink component carrier is a primary component carrier and the remaining uplink component carriers are secondary component carriers. For example, the downlink component carrier D1 and the uplink component carrier U1 are primary component carriers, and the remaining component carriers D2, U2, D3, and U3 are secondary component carriers.

In an FDD component carrier, downlink component carriers D1, D2, and D3 and uplink component carriers U1, U2, and U3 are respectively connected together one-to-one.

The downlink component carrier and the uplink component carrier are connected to form a serving cell. However, a serving cell is not formed with only one uplink component carrier. The serving cell may be defined as a component frequency band that may be aggregated by carrier aggregation. The serving cell may include a primary serving cell and a secondary serving cell. The primary serving cell is a serving cell that provides a security input and NAS mobility information in an RRC establishment or re-establishment state. At least one cell may form a serving cell set together with a primary serving cell according to capabilities of the terminal 200, and at least one cell is referred to as a secondary serving cell. A serving cell set that is formed in one terminal 200 may include only a primary serving cell, or may include a primary serving cell and at least one secondary serving cell. The primary serving cell always has both an uplink primary component carrier and a downlink primary component carrier, and the secondary serving cell may have both an uplink secondary component carrier and a downlink secondary component carrier or may have only a downlink secondary component carrier.

The primary serving cell is always activated, but the secondary serving cell is activated or deactivated according to a specific condition. The specific condition may be a case of receiving an activation/deactivation indicator of a base station or a case in which a deactivation timer within the terminal 200 is terminated. Activation indicates a state in which data is transmitted or received or in which data is in a ready state. Deactivation indicates a state in which data and control information of the data cannot be transmitted or received but minimal measurement information can be transmitted and received.

A downlink component carrier corresponding to a primary serving cell is referred to as a downlink primary component carrier (DL PCC), and an uplink component carrier corresponding to a primary serving cell is referred to as an uplink primary component carrier (UL PCC). Further, in a downlink, a component carrier corresponding to a secondary serving cell is referred to as a downlink secondary component carrier (DL SCC), and in an uplink, a component carrier corresponding to a secondary serving cell is referred to as an uplink secondary component carrier (UL SCC).

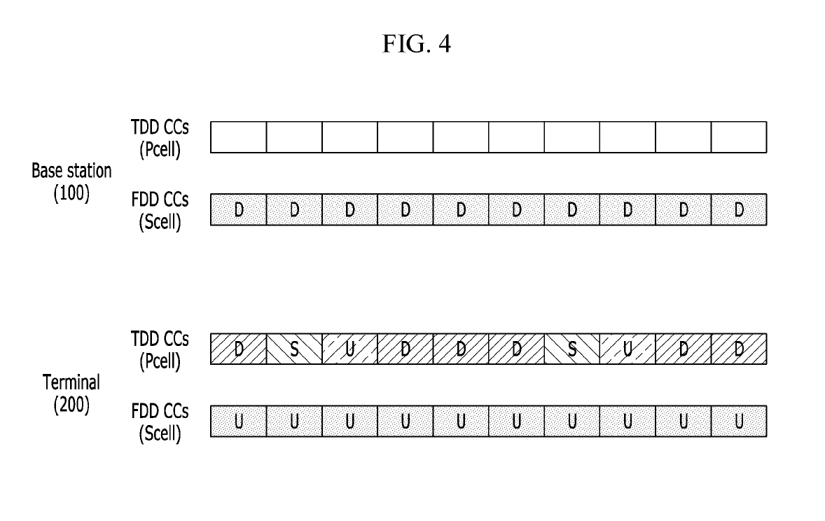

FIG. 4 is a diagram illustrating an example of a method of allocating a serving cell in a base station according to an exemplary embodiment of the present invention.

Referring to FIG. 4, the base station 100 sets TDD component carriers (TDD CCs) to a primary serving cell (Pcell) of the terminal 200, and sets at least one FDD component carrier (FDD CCs) to a secondary serving cell (Scell) of the terminal 200. The base station 100 transmits resource allocation information and data through a downlink component carrier of the Pcell or the Scell. The resource allocation information may be transmitted through a Physical Downlink Control Channel (PDCCH), and data may be transmitted through a Physical Downlink Shared CHannel (PDSCH).

The terminal 200 transmits HARQ feedback through a UL PCC of the Pcell, and transmits data through an uplink component carrier of the Pcell or the Scell. In the TDD, time points of uplink and downlink are divided, and when various TDD configurations exist, such time point may be various.

Table 1 illustrates an example of TDD uplink-downlink configurations.

TABLE 1

| Uplink- | Downlink- | | | | | | | | | | |
|---|---|---|---|---|---|---|---|---|---|---|---|
| downlink | to-Uplink | | | | | | | | | | |
| Con- | Switch-point | Subframe number | | | | | | | | | |
| figuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, in a radio frame corresponding to 10 subframes, an area that is represented with D is a downlink, and an area that is represented with U is an uplink. S is a subframe (Downlink-to-Uplink Switch-point periodicity) that is converted from a downlink to an uplink with a special subframe.

As shown in Table 1, at each TDD uplink-downlink configuration, different uplink-downlink subframe transmission timing exists. Particularly, a HARQ round trip time (RTT) may be different at every TDD uplink-downlink configuration. Further, the HARQ RTT may be different according to a wireless environment of a terminal. The HARQ RTT is a time from a time point at which a transmitter transmits data to a time point immediately before retransmitting data after receiving a feedback signal of data transmission from a receiver. The HARQ RTT may include processing delay, which is a time necessary for data processing in the transmitter and the receiver.

The base station 100 allocates a TDD uplink-downlink configuration to a TDD component carrier of a Pcell. In FIG. 4, a TDD uplink-downlink configuration 2 is allocated to a TDD component carrier of the Pcell.

The terminal 200 may know a HARQ feedback transmitting time point according to a TDD uplink-downlink configuration that is set to a TDD component carrier of the Pcell.

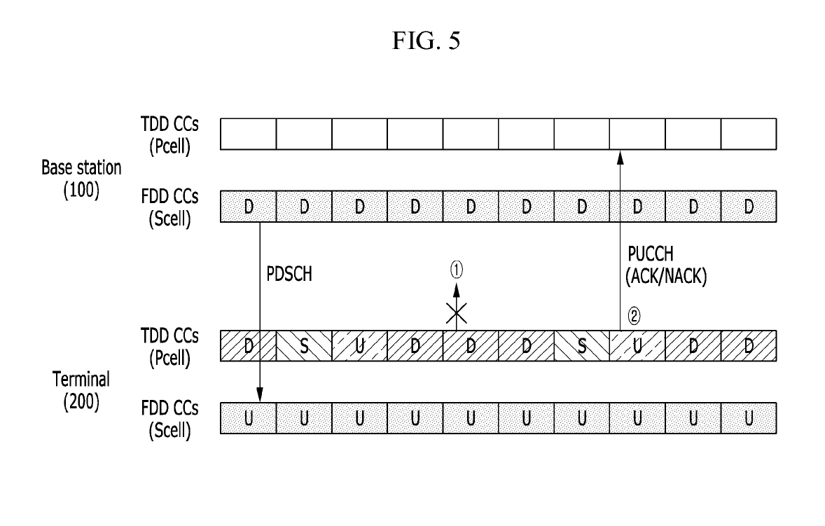

FIG. 5 is a diagram illustrating a HARQ technique according to an exemplary embodiment of the present invention.

As shown in FIG. 5, the base station 100 sets TDD CCs to a Pcell of the terminal 200 and sets at least one FDD CC to an Scell of the terminal 200. Further, the base station 100 sets a TDD uplink-downlink configuration 2 to the Pcell.

The base station 100 transmits data through a PDSCH of the Scell.

When the terminal 200 receives data, the terminal 200 decodes data and transmits HARQ feedback according to a decoding result. In this case, it is assumed that at least 3 frames are necessary for receiving and decoding data.

The terminal 200 may transmit feedback of data through a subframe of a time point \textcircled{1} at which 3 frames have elapsed after receiving data. When data decoding has succeeded, the terminal 200 transmits an ACK signal as a HARQ feedback signal to an uplink, and when data decoding has failed, the terminal 200 transmits a NACK signal. Feedback of data is generally transmitted through a Pcell. Therefore, the terminal 200 cannot transmit a HARQ feedback signal of data through a subframe of the time point \textcircled{1}.

The terminal 200 transmits a HARQ feedback signal of data through a PUCCH of a subframe of a time point \textcircled{2} after awaiting the subframe of the time point \textcircled{2} by a TDD uplink-downlink configuration 2.

In this way, a HARQ feedback signal is delayed by allocation of a TDD uplink-downlink configuration 2 and thus data transmission may also be delayed.

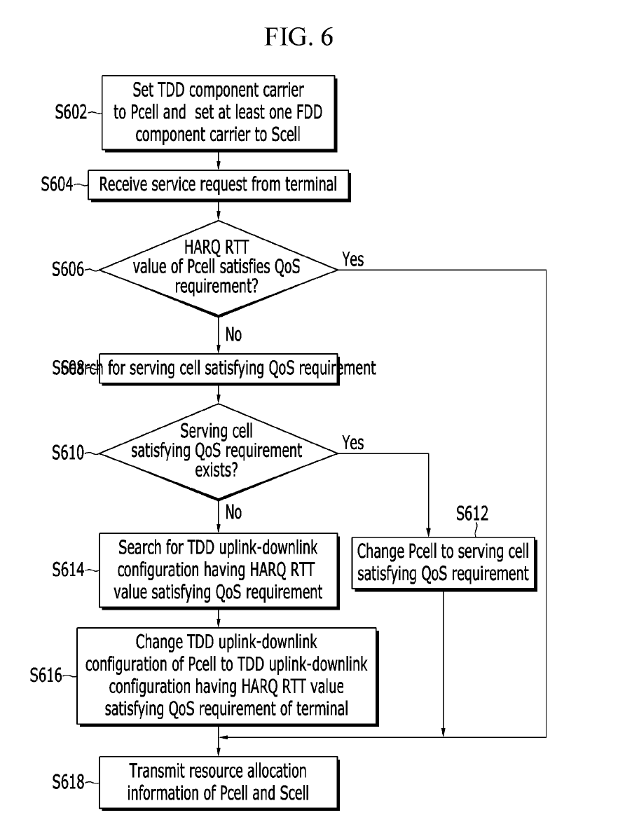

Hereinafter, an exemplary embodiment that can solve data transmission delay due to delay of a HARQ feedback signal will be described in detail with reference to FIGS. 6 to 8.

FIG. 6 is a flowchart illustrating a method of allocating a resource of a base station according to a first exemplary embodiment of the present invention.

Referring to FIG. 6, the base station 100 sets a TDD CC to a Pcell of the terminal 200, and sets at least one FDD CC to an Scell of the terminal 200 (S602).

The terminal 200 sends a request for a service to the base station 100. The service request may include a QoS requirement of the terminal 200. The QoS requirement may include transmission delay and transmission speed.

When the base station 100 receives a service request from the terminal 200 (S604), the base station 100 determines whether a HARQ RTT value of the Pcell that is set to the terminal 200 satisfies a QoS requirement of a service that the terminal 200 requests (S606).

If a HARQ RTT value of the Pcell that is set to the terminal 200 does not satisfy the QoS requirement of a service that the terminal 200 requests, the base station 100 searches for a serving cell satisfying the QoS requirement of the terminal 200 (S608).

The base station 100 determines whether a serving cell satisfying the QoS requirement of the terminal 200 exists (S610), and if a serving cell satisfying the QoS requirement of the terminal 200 exists, the base station 100 changes the Pcell to a serving cell satisfying the QoS requirement of the terminal 200 (S612). The change of the Pcell may be performed through handover.

If a serving cell satisfying the QoS requirement of the terminal 200 does not exist, the base station 100 searches for a TDD uplink-downlink configuration having a HARQ RTT value satisfying the QoS requirement of the terminal 200 in TDD uplink-downlink configurations (S614).

When a TDD uplink-downlink configuration having a HARQ RTT value satisfying the QoS requirement of the terminal 200 exists, the base station 100 changes a TDD uplink-downlink configuration of the Pcell to a TDD uplink-downlink configuration having a HARQ RTT value satisfying the QoS requirement of the terminal 200 (S616).

The base station 100 transmits resource allocation information of the Pcell and the Scell that are set to the terminal 200 to the terminal 200 (S618).

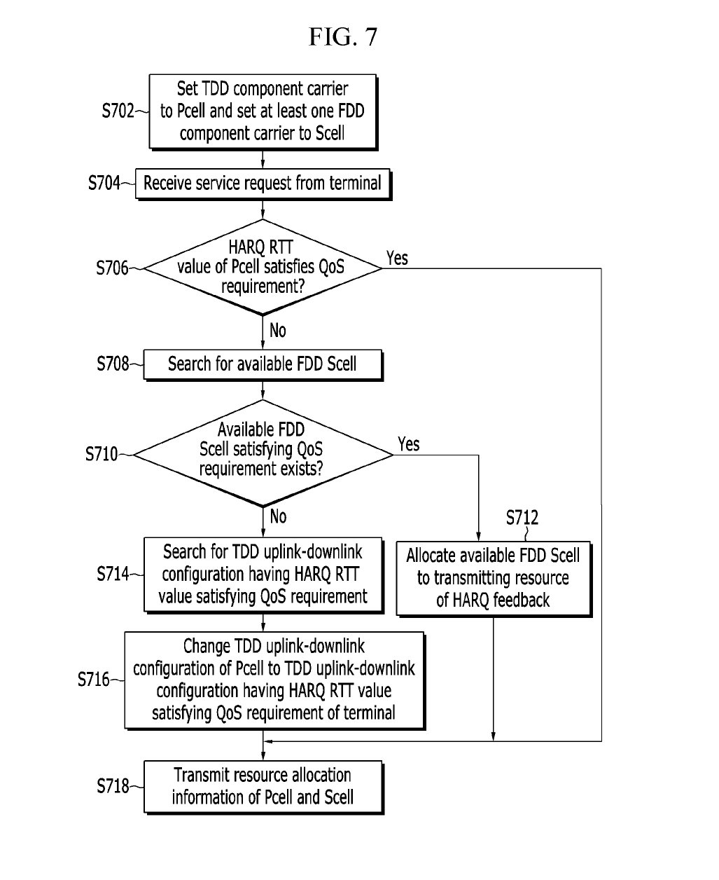

FIG. 7 is a flowchart illustrating a method of allocating a resource of a base station according to a second exemplary embodiment of the present invention.

Referring to FIG. 7, the base station 100 sets a TDD CC to a Pcell of the terminal 200, and sets at least one FDD CC to an Scell of the terminal 200 (S702).

When the base station 100 receives a service request from the terminal 200 (S704), the base station 100 determines whether a HARQ RTT value of the Pcell that is set to the terminal 200 satisfies the QoS requirement of a service that the terminal 200 requests (S706).

If a HARQ RTT value of the Pcell that is set to the terminal 200 does not satisfy the QoS requirement of a service that the terminal 200 requests, the base station 100 searches for an available FDD Scell (S708). An available FDD Scell is an FDD Scell having a HARQ RTT value satisfying the QoS requirement of a service that the terminal 200 requests.

The base station 100 determines whether an available FDD Scell exists (S710), and if an available FDD Scell exists, the base station 100 allocates an available FDD Scell to a transmitting resource of HARQ feedback (S712). Thereafter, the terminal 200 transmits HARQ feedback through a PUCCH of a component carrier of an available FDD Scell.

If an available FDD Scell does not exist, the base station 100 searches for a TDD uplink-downlink configuration having a HARQ RTT value satisfying the QoS requirement of the terminal 200 in TDD uplink-downlink configurations (S714).

When a TDD uplink-downlink configuration having a HARQ RTT value satisfying the QoS requirement of the terminal 200 exists, the base station 100 changes the TDD uplink-downlink configuration of the Pcell to TDD uplink-downlink configuration having a HARQ RTT value satisfying the QoS requirement of the terminal 200 (S716).

The base station 100 transmits resource allocation information of the Pcell and the Scell that are set to the terminal 200 to the terminal 200 (S718).

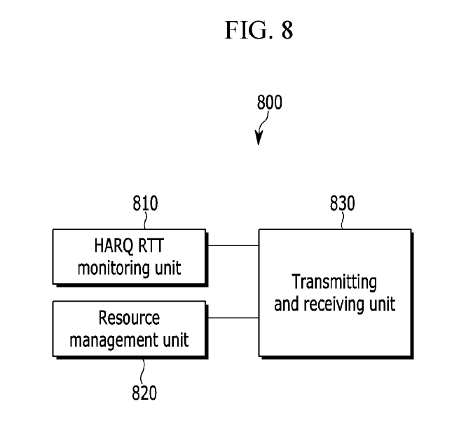

FIG. 8 is a block diagram illustrating a configuration of a resource allocation apparatus of a base station according to an exemplary embodiment of the present invention.

Referring to FIG. 8, a resource allocation apparatus 800 of the base station 100 may include a HARQ RTT monitoring unit 810, a resource management unit 820, and a transmitting and receiving unit 830.

The HARQ RTT monitoring unit 810 monitors a HARQ RTT value that is set to a TDD CC and an FDD CC. The HARQ RTT monitoring unit 810 transfers a HARQ RTT value of a TDD CC and an FDD CC to the resource management unit 820.

The resource management unit 820 manages a plurality of component carriers and allocates a component carrier to the terminal 200. Particularly, the resource management unit 820 may allocate a TDD CC to a Pcell and allocate at least one FDD CC to an Scell. The resource management unit 820 may change a Pcell that is set to the terminal 200 based on a method that is described with reference to FIG. 6, and change a TDD uplink-downlink configuration of a Pcell based on a method that is described with reference to FIGS. 6 and 7. Further, the resource management unit 820 may change a transmitting resource of HARQ feedback from a Pcell to an Scell based on a method that is described with reference to FIG. 7.

The transmitting and receiving unit 830 transmits resource allocation information of a Pcell and an Scell that are set to the terminal 200 by the resource management unit 820 to the terminal 200. Further, the transmitting and receiving unit 830 receives HARQ feedback from the terminal 200.

In the foregoing carrier aggregation system according to an exemplary embodiment of the present invention, at least a partial function of a method and apparatus for allocating a resource may be implemented with hardware or with software that is combined to hardware. For example, a processor that is implemented with a central processing unit (CPU) or other chipset and microprocessor may perform a function of the HARQ RTT monitoring unit 810 and the resource management unit 820, and a transceiver may perform a function of the transmitting and receiving unit 830.

According to an exemplary embodiment of the present invention, when a base station and a terminal aggregate and use several FDD and TDD component carriers without violating a present 3GPP specification, delay of user data due to delay of a HARQ feedback signal can be minimized.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of allocating a resource in a base station of a carrier aggregation system that aggregates and communicates a plurality of component carriers, the method comprising:
setting a time division duplex (TDD) component carrier of a plurality of TDD component carriers to a primary serving cell of a terminal and setting at least one frequency division duplex (FDD) component carrier of a plurality of FDD component carriers to a secondary serving cell of a terminal;
receiving a service request from the terminal; and
changing a HARQ feedback transmitting resource that is set to the terminal, when a hybrid automatic repeat request-round trip time (HARQ RTT) value of a TDD component carrier of the primary serving cell of the terminal does not satisfy a quality of service (QoS) requirement of a service that the terminal requests.

2. The method of claim 1, wherein the changing a HARQ feedback transmitting resource comprises setting a primary serving cell of the terminal to a TDD component carrier having a HARQ RTT value satisfying the QoS requirement of a service that the terminal requests among the plurality of TDD component carriers.

3. The method of claim 2, further comprising receiving HARQ feedback from the terminal through the primary serving cell.

4. The method of claim 1, wherein the changing of a HARQ feedback transmitting resource comprises setting a HARQ feedback transmitting resource of the terminal to a secondary serving cell satisfying the QoS requirement of a service that the terminal requests.

5. The method of claim 4, further comprising receiving HARQ feedback from the terminal through the secondary serving cell.

6. The method of claim 1, wherein the changing of a HARQ feedback transmitting resource comprises changing a TDD uplink-downlink configuration of a TDD component carrier of the primary serving cell to a TDD uplink-downlink configuration satisfying the QoS requirement of a service that the terminal requests.

7. The method of claim 1, wherein the QoS requirement comprises transmission delay.

8. The method of claim 1, further comprising monitoring a HARQ RTT value of the plurality of TDD component carriers and the plurality of FDD component carriers.

9. The method of claim 1, wherein the primary serving cell comprises a primary component carrier that is allocated to an uplink and a primary component carrier that is allocated to a downlink as a pair, and the secondary serving cell comprises a secondary component carrier that is allocated to an uplink and a secondary component carrier that is allocated to a downlink as a pair or only a secondary component carrier that is allocated to a downlink.

10. A resource allocation apparatus that allocates a resource in a carrier aggregation system that aggregates and communicates a plurality of time division duplex (TDD) component carriers and a plurality of frequency division duplex (FDD) component carriers, the resource allocation apparatus comprising:
a HARQ RTT monitoring unit that monitors a hybrid automatic repeat request-round trip time (HARQ RTT) value of the plurality of TDD component carriers and the plurality of FDD component carriers; and
a resource management unit that changes a HARQ feedback transmitting resource that is set to a terminal according to a quality of service (QoS) requirement of a service that the terminal requests in a state that sets a TDD component carrier of a plurality of TDD component carriers to a primary serving cell of the terminal and that sets at least one FDD component carrier of a plurality of FDD component carriers to a secondary serving cell of the terminal.

11. The resource allocation apparatus of claim 10, wherein the resource management unit changes a TDD component carrier of a primary serving cell of the terminal to a TDD component carrier having a HARQ RTT value satisfying the QoS requirement of a service that the terminal requests, and
a transmitting resource of the HARQ feedback comprises the primary serving cell.

12. The resource allocation apparatus of claim 10, wherein the resource management unit changes a transmitting resource of the HARQ feedback from the primary serving cell to a secondary serving cell satisfying the QoS requirement of a service that the terminal requests among the at least one secondary serving cell.

13. The resource allocation apparatus of claim 10, wherein the resource management unit changes a TDD uplink-downlink configuration of a primary serving cell of the terminal to use as a transmitting resource of the HARQ feedback based on the QoS requirement of a service that the terminal requests.

14. The resource allocation apparatus of claim 10, wherein the QoS requirement comprises transmission delay.

15. The resource allocation apparatus of claim 10, further comprising a transmitting and receiving unit that transmits resource allocation information of a primary serving cell and a secondary serving cell to set to the terminal and that receives HARQ feedback through the HARQ feedback transmitting resource from the terminal.
